(19) United States
(12) Patent Application Publication
(10) Pub. No.: US 2015/0198816 A1
(43) Pub. Date: Jul. 16, 2015

(54) Lens driving device

(71) Applicant: Leping Dong, Shenzhen (CN)

(72) Inventor: Leping Dong, Shenzhen (CN)

(73) Assignee: AAC Technologies Pte. Ltd., Singapore City (SG)

(21) Appl. No.: 14/446,859

(22) Filed: Jul. 30, 2014

(30) Foreign Application Priority Data
Jan. 10, 2014 (CN) 201410013523.X
Jan. 10, 2014 (CN) 201420015990.1

(51) Int. Cl. G02B 27/64; G02B 7/04

(52) U.S. Cl. CPC G02B 27/646; G02B 7/04

(57) ABSTRACT

Disclosed is a lens driving device for performing the function of anti-shaking. The device includes a shell having a base and a cover coupled with the base for forming a receiving space, a frame disposed in the receiving space, a moving unit disposed in the frame, a circuit board, a driving magnet unit having a first part and a second part, a driving coil, a anti-shaking coil disposed on the joining line of the first part and the second part, and a first position detecting unit for detecting the position of the frame. The area of the first part is greater than that of the second part.

### FIELD OF THE INVENTION

The disclosure described herein relates generally to driving devices, and more particularly, to a device for driving a lens.

### DESCRIPTION OF RELATED ART

With the development of camera technologies, lens driving devices are widely used in various digital devices equipped with cameras, like cellphones, video cameras, laptop computers and so on.

A lens driving device used in a digital device usually includes a lens holder, a lens disposed in the lens holder, a coil wound around the lens holder and a magnet fixed with the lens holder. When electrified, the coil generates an electromagnetic force together with the magnet which drives the lens holder move along the optic axis of the lens. However, the related lens driving device does not have any anti-shaking functions.

Therefore, an improved lens driving is provided in the present disclosure to solve the problem mentioned above.

### BRIEF DESCRIPTION OF THE DRAWINGS

FIG. 1 illustrates an isometric view of a lens driving device in accordance with an exemplary embodiment of the present disclosure.

FIG. 2 illustrates a cross-sectional view of the lens driving device taken along line A-A in FIG. 1.

FIG. 3 is an exploded view of the lens driving device.

FIG. 4 is an isometric view of the lens driving device, with a shell, a yoke, a circuit board, and an upper elastic plate thereof being removed away.

FIG. 5 is a top view of the lens driving device in FIG. 4

FIG. 6 is an assembled view of a combination of the circuit board, an anti-shaking coil, a first position detecting unit, and a second position detecting unit of the lens driving device.

FIG. 7 is an illustration of an arrangement of a driving magnet unit, a driving coil and the anti-shaking coil of the lens driving device.

Many aspects of the embodiment can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENT

Reference will now be made to describe the exemplary embodiment of the present invention in detail.

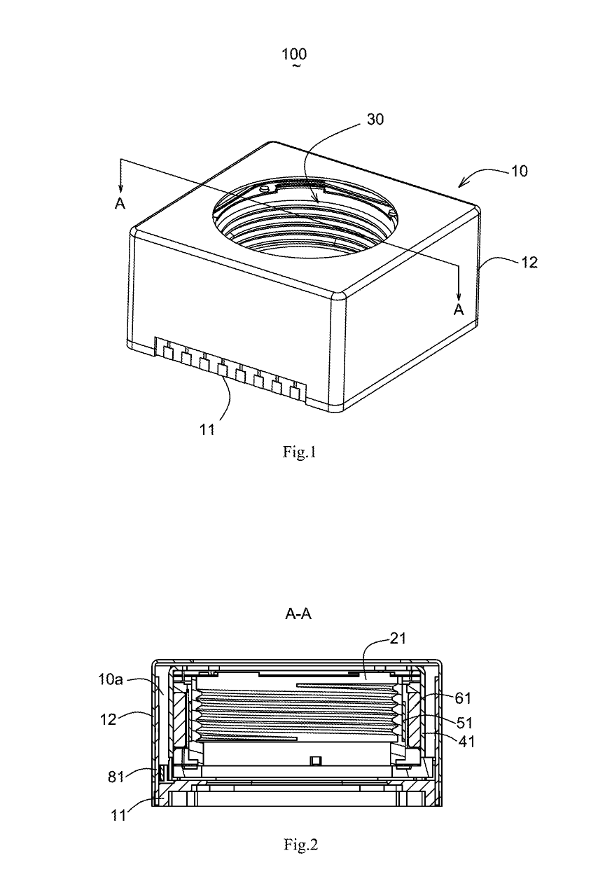

Referring to FIGS. 1-2, the lens driving device 100 for driving a lens comprises a shell 10 having a base 11 and a cover 12 coupled with the base 11 for forming a receiving space 10a, a moving unit received in the receiving space 10a, a driving unit for driving the moving unit to move and a circuit unit for detecting the position of the moving unit related to the shell 10 and providing external power to the lens driving device 100.

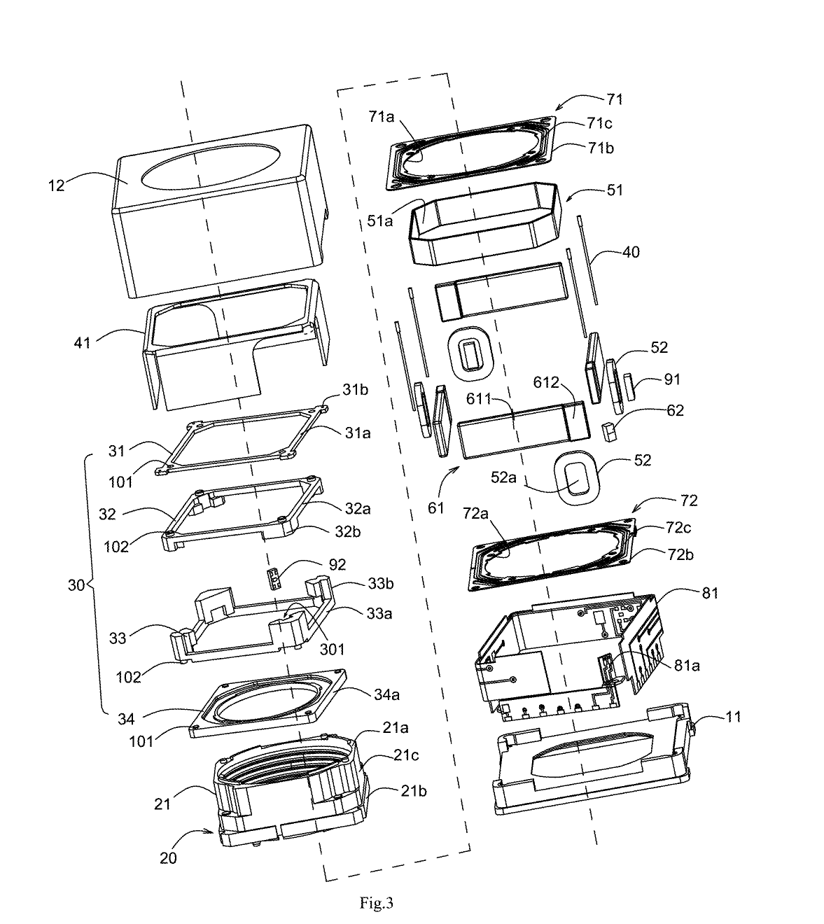

Referring to FIG. 3, the moving unit has a frame 30 received in the receiving space 10a, at least one connecting part 40 connected with the shell 10 and the frame 30 for elastically supporting the frame 30 in the shell 10, a lens holder 21 received in the frame 30 for accommodating the lens, a detected magnet unit 62 fixed on the lens holder 21 and an elastic unit attached on the frame 30 and connected with the lens holder 21 for elastically supporting the lens holder 21.

The frame 30 comprises a first frame 31 having a first body portion 31a, a second frame 32 having a second body portion 32a attached on the first body portion 31a and at least four first legs 32b extending from the second body portion 32a, a third frame 33 having a third body portion 33a far away from the second body portion 32a and at least four second legs 33b extending from the third body portion 33a toward the second frame 32, and a fourth frame 34 having a fourth body portion 34a attached on the third body portion 33a. Therefore, the four frames 31, 32, 33, 34 are disposed and stacked in sequence. The first frame 31 is farther away from the base 11 than the fourth frame 34. The frame 30 further has a fixing member provided between the first frame 31 and the second frame 32 for fixing the first frame 31 on the second frame 32 firmly, and the fixing member is also provided between the third frame 33 and the fourth frame 34 for fixing the third frame 33 on the fourth frame 34 firmly. The fixing member comprises at least one accommodating hole 101 provided in the first frame 31 and at least one pin 102 extending from the second body portion 32a towards the first frame 31 and accommodating in the corresponding accommodating hole 101. The fixing member further comprises at least one pin 102 extending from the third body portion 33a toward the fourth frame 34 and at least one accommodating hole 101 provided in the fourth frame 34. In this embodiment, the four frames 31, 32, 33, 34 are configured to be rectangular. In an alternative embodiment, the number of the frame is variable corresponding to actual requirements.

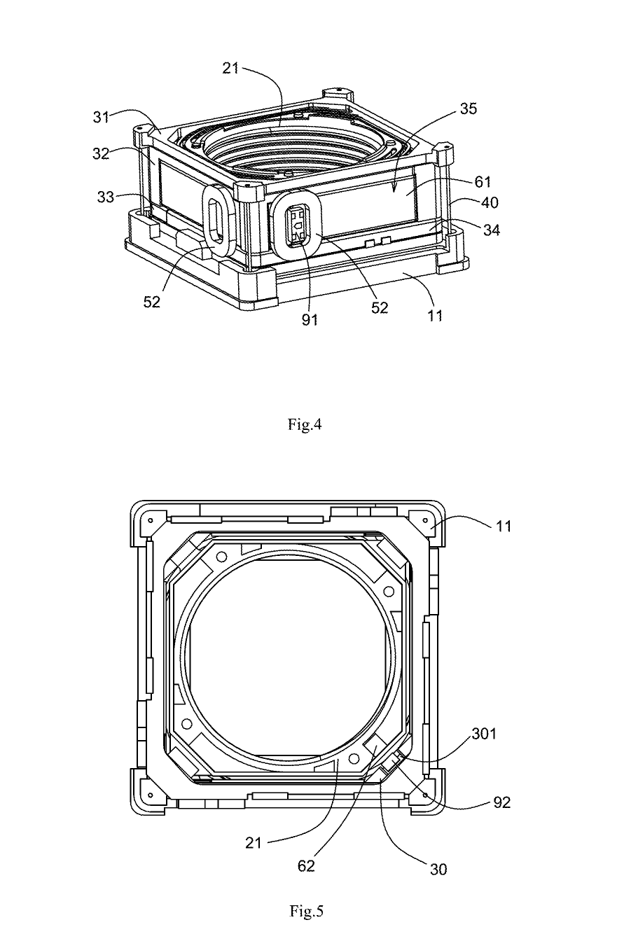

Referring back to FIG. 2, the driving unit has a driving coil 51 electrically coupled with the circuit unit attached on the lens holder 21, a yoke 41 covering the frame 30 and a driving magnet unit 61 attached on the frame 30 (referring to FIG. 4). Alternatively, the driving coil 51 is attached on the frame 30 and the driving magnet unit 61 is attached on the lens holder 21. The driving magnet unit 61 interacts with the driving coil 51 for generating a magnetic force for driving the lens holder 21 to move along an optical axis of the lens. The driving unit further has an anti-shaking coil 52 attached on the circuit unit for interacting with the driving magnet unit 61 for driving the frame 30 to move along a direction perpendicular to the optical axis of the lens. The lens holder 21 has a surrounding peripheral wall 21c and the driving coil 51 has an inner surface 51a engaging with the surrounding peripheral wall 21c.

Referring to FIG. 3 and FIG. 4, furthermore, a surface of the first legs 32b opposite to the third frame 33 engages with a surface of the second legs 33b opposite to the second frame 32 thereby forming a receiving portions 35 for receiving the driving magnet unit 61. The second leg 33b has a surface near the lens holder 21 and a concavity 301 for receiving the second position detecting unit 92 extending from the surface along a direction far away from the lens holder 21 (referring to FIG. 5). In this embodiment, the first legs 32b forms four receiving portions 35 together with the second legs 33b, and the lens driving device 100 has four driving magnet units 61 and the four driving magnet units 61 are symmetrical with respect to the optical axis of the lens.

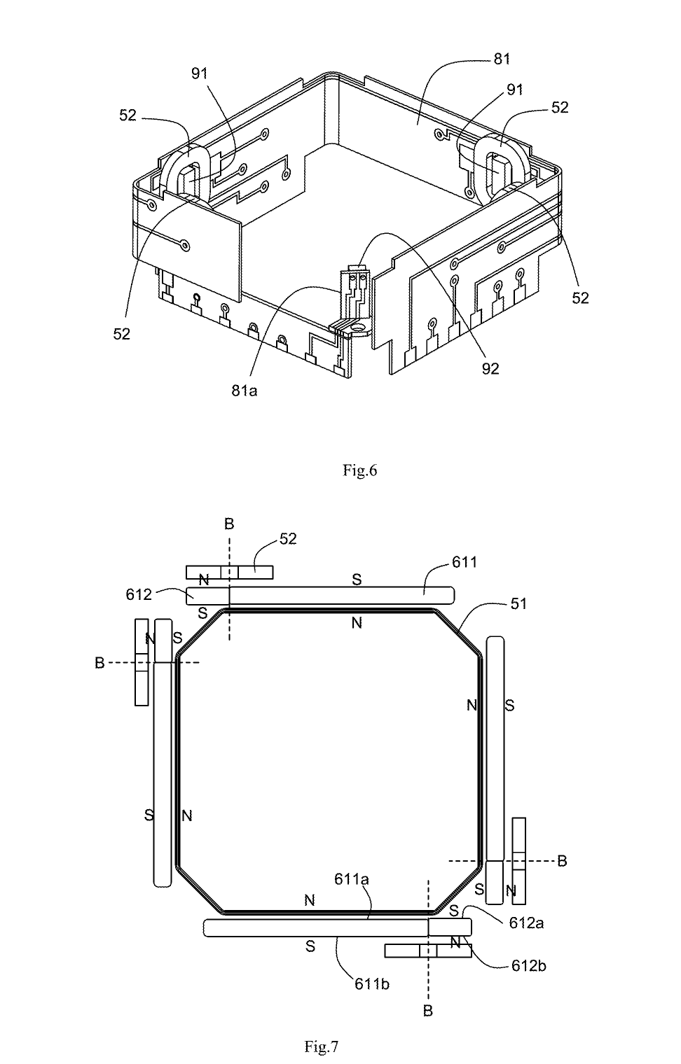

Referring to FIG. 6, the circuit unit has a circuit board 81 attached on an inner surface of the cover 12, a first position detecting unit 91 mounted on the circuit board 81 and electrically connected to the circuit board 81, a second position detecting unit 92 mounted on the circuit board 81 and electrically connected to the circuit board 81, and a detected magnet unit 62 fixed on the lens holder 21. Referring to FIG. 5, the second position detecting unit 92 is opposite to the detected magnet unit 62.

Referring back to FIG. 3, the lens holder 21 further has an upper end 21a and a lower end 21b. The surrounding peripheral wall 21c connects the upper end 21a and the lower end 21b. The elastic unit comprises an upper elastic plate 71 and a lower elastic plate 72 opposite to the upper elastic plate 71. The upper elastic plate 71 has a first inner annular part 71a, a first outer edge 71b separated from the first inner annular part 71a and surrounding the first inner annular part 71a, and a first elastic connecting part 71c connecting the first inner annular part 71a and the first outer edge 71. The lower elastic plate 72 has a second inner annular part 72a, a second outer edge 72b separated from the second inner annular part 72a and surrounding the second inner annular part 72a, and a second elastic connecting part 72c connecting the second inner annular part 72a and the second outer edge 72b. The first inner annular part 71a is fixed on the upper end 21a of the lens holder 21, and the first outer edge 71b is fixed on the first frame 31. The second inner annular part 72a is fixed on the lower end 21b of the lens holder 21, and the second outer edge 72b is sandwiched between the third body portion 33a of the third frame 33 and the fourth body portion 34a of the fourth frame 34.

Referring to FIG. 3 and FIG. 7, each of the driving magnet units 61 comprises a first part 611 and a second part 612 connected with the first part 611. In this exemplary embodiment, the first part 611 is separated from the second part 612. Alternatively, the first part and the second part also can be formed as an integral one piece part. The first part 611 has a first inner pole 611a near the lens holder 21 and a first outer pole 611b opposite to the first inner pole 611a. The second part 612 has a second inner pole 612a near the lens holder 21 and a second outer pole 612b opposite to the second inner pole 612a. The area of the first inner pole 611a is greater than that of the second inner pole 612a and the area of the first outer pole 611b is greater than that of the second outer pole 612b which makes it possible that the magnetic force is generated by the driving magnet unit 61 interacting with the driving coil 51 to drive the lens holder 21 to move along an optical axis of the lens. Optionally, the area of the first inner pole 611a is at least three times greater than that of the second inner pole 612a, and the area of the first outer pole 611b is at least three times greater than that of the second outer pole 612b. In this exemplary embodiment, the area of the first inner pole 611a is equal to that of the first outer pole 611b, and the area of the second inner pole 612a is equal to that of the second outer pole 612b. The magnetizing directions of the first part 611 and the second part 612 are both vertical to the optical axis of the lens. Furthermore, the polarity of the first inner pole 611a and the polarity of the second inner pole 612a are reversed to each other, and the polarity of the first outer pole 611b and the polarity of the second outer pole 612b are reversed to each other.

The driving magnet unit 61 has two functions in the present disclosure, one of which is interacting with the driving coil 51 for generating a magnetic force for driving the lens holder 21 to move along an optical axis of the lens, the other of which is interacting with the anti-shaking coil 52 for driving the frame 30 to move along a direction perpendicular to the optical axis of the lens thereby achieving the purpose of anti-shaking. The driving coil 51 is electrically connected to the circuit board 81 and is opposite to the driving magnet units 61, the electromagnetic force generated by the driving coil 51 and the first part 611 drives the lens holder 21 move along the direction of the optical axis. The anti-shaking coil 52 having a central hole 52a is attached on the circuit board 81 and electrically connected to the circuit board 81. Referring to FIG. 7, the anti-shaking coil 52 is attached on the circuit board 81 and disposed on a joining line B formed by the first part 611 and the second part 612. The anti-shaking coil 52 is symmetrical with respect to the joining line B. Because the polarity of the first outer pole 611b and the polarity of the second outer pole 612b are reversed to each other, the direction of the electromagnetic force generated by the anti-shaking coil 52 and the first outer pole 611b is the same as the direction of the electromagnetic force generated by anti-shaking coil 52 and the second outer pole 612b, so that, the total electromagnetic force generated by the anti-shaking coil 52 interacting with the first outer pole 611b and the second outer pole 612b drives the frame 30 to move along the direction perpendicular to the optical axis of the lens.

Referring to FIG. 4, the first position detecting unit 91 is disposed in the central hole 52a of the anti-shaking coil 52 and faces to the driving magnet unit 61. The first position detecting unit 91 is a hall element for detecting a movement signal of the lens holder 21 along a direction perpendicular to the optical axis of the lens by detecting the magnetic force of the driving magnet unit 61 and sending the movement signal to the circuit board 81. Then, the circuit board 81 generates a controlling signal according to the movement signal and transmits the controlling signal to the anti-shaking coil 52. The direction of the electromagnetic force generated by the anti-shaking coil 52 interacting with the driving magnet unit 61 is opposite to that of the shaking which can draws the frame 30 back when the shaking happens so that achieving the purpose of anti-shaking.

Referring to FIG. 3 and FIG. 5, the second position detecting unit 92 is disposed in the concavity 301 and is opposite to the detected magnet unit 62. Referring to FIG. 6, the circuit board 81 has an extending portion 81a extending into the concavity 301 for electrically coupled with the second position detecting unit 92. The second position detecting unit 92 is also a hall element for detecting a movement signal of the lens holder 21 by detecting the magnetic force of the detected magnet unit 62 and feeding the movement signal back to the circuit board 81, so, the circuit board 81 generates a controlling current for controlling the lens driving device 100 to focus quickly and accurately.

While the present disclosure has been described with reference to the specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

What is claimed is:

1. A lens driving device for driving a lens, comprising:
a shell having a base and a cover coupled with the base for forming a receiving space;
a moving unit disposed in the receiving space, comprising a frame elastically supported in the receiving space, a connecting part connected with the shell and the frame for elastically supporting the frame in the shell, a lens holder received in the frame, and an elastic unit attached on the frame and connected with the lens holder for elastically supporting the lens holder;
a circuit board disposed in the receiving space and attached on an inner surface of the cover;
a driving magnet unit disposed on the frame, comprising a first part and a second part connected with the first part, the first part having a first inner pole near the lens holder and a first outer surface opposite to the first inner pole; the second part having a second inner pole near the lens holder and a second outer pole opposite to the second inner pole, the area of the first inner pole being greater than that of the second inner pole, and the area of the first outer pole being greater than that of the second outer pole, the polarization of the first inner pole and the polarization of the second inner pole being reversed to each other, the polarization of the first outer pole and the polarization of the second outer pole being reversed to each other;
a driving coil surrounding a periphery of the lens holder and opposite to the driving magnet unit, for generating electromagnetic force for driving the lens holder to move along the direction of the optical axis of the lens;
an anti-shaking coil attached on the circuit board, having a central hole, the anti-shaking coil being disposed on a joining line of the first part and the second part and facing to the first outer pole and the second outer pole for generating electromagnetic force for driving the frame move on a direction perpendicular to the optical axis of the lens; and
a first position detecting unit electrically connected with the circuit board and disposed in the central hole of the anti-shaking coil for detecting the position of the frame.

2. The lens driving device as described in claim 1, wherein the frame comprises a first frame, a second frame having at least one first leg, a third frame having at least one second leg, and a fourth frame, a surface of the first leg opposite to the third frame engaging with a surface of the second leg opposite to the second frame for forming a receiving portion for receiving the driving magnet unit.

3. The lens driving device as described in claim 2, wherein the lens driving device further comprises a second position detecting unit disposed on the frame for detecting the position of the lens holder and electrically connected with the circuit board, and a detected magnet unit mounted on the lens holder and facing to the second position detecting unit, the second leg has a surface near the lens holder and a concavity for receiving the second position detecting unit extending from the surface along a direction far away from the moving unit.

4. The lens driving device as described in claim 3, wherein the circuit board further comprises an extending portion extending into the concavity, the second position detecting unit is attached on the extending portion and electrically connected with the extending portion.

5. The lens driving device as described in claim 2, wherein the frame further has a fixing member provided between the first frame and the second frame for fixing the first frame on the second frame firmly, and provided between the third frame and the fourth frame for fixing the third frame on the fourth frame firmly.

6. The lens driving device as described in claim 1, wherein the area of the first inner pole is at least three times greater than that of the second inner pole, and the area of the first outer pole is at least three times greater than that of the second outer pole.

7. The lens driving device as described in claim 1, wherein the elastic unit comprises an upper elastic plate having a first inner annular part, a first outer edge separated from the first inner annular part and a first elastic connecting part connecting the first inner annular part and the first outer edge, the lens holder has an upper end and a lower end, the first inner annular part is fixed with the upper end of the lens holder, the first outer edge is fixed with the first frame.

8. The lens driving device as described in claim 7, wherein the elastic unit further comprises a lower elastic plate having a second inner annular part, a second outer edge separated from the second inner annular part and a second elastic connecting part connecting the second inner annular part and the second outer edge, the second inner annular part is fixed with the lower end of the lens holder, the second outer edge is sandwiched between the third frame and the fourth frame.

9. The lens driving device as described in claim 1, wherein the anti-shaking coil is symmetrical about the jointing line of the first part and the second part.
